(19) United States
(12) Patent Application Publication
(10) Pub. No.: US 2009/0055364 A1
(43) Pub. Date: Feb. 26, 2009

(54) DECLARATIVE VIEWS FOR MAPPING

(75) Inventors: Srikanth Mandadi, Redmond, WA (US); Shyamalan Pather, Seattle, WA (US); Atul Adya, Redmond, WA (US); Timothy Mallalieu, Sammamish, WA (US); Daniel Gerard Dosen, Seattle, WA (US); Colin Joseph Meek, Redmond, WA (US); Ju-Yi Kuo, Sammamish, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/842,629

(22) Filed: Aug. 21, 2007

(51) Int. Cl. G06F 7/00

(52) U.S. Cl. 707/4

(57) ABSTRACT

The claimed subject matter provides systems and methods that effectuates and facilitates the generation of bidirectional views. The disclosed system can include components that transform queries and mappings into an internal representation that can be compiled into a bidirectional view. The bidirectional view can thereafter be employed to actuate query and update processing in a relational database management system.

### BACKGROUND

Developers of data-centric solutions routinely face situations in which data representations used by applications differ substantially from ones used by databases. A traditional reason for this distinction has included impedance mismatches between programming language abstractions and persistent storage; developers want to encapsulate business logic into objects, yet most enterprise data is stored in relational database systems. A further reason for the distinction is to enable data independence. Even if applications and databases start with the same data representation, they can evolve, leading to differing data representations that must be bridged or mapped. Yet a further reason is independence from Data Base Management System (DBMS) vendors: many enterprise applications run in the middle tier and need to support backend database systems of varying capabilities, which can require different data representations. Thus, in many enterprise systems separation between application models and database models has become a design choice rather than a technical impediment.

The data transformations required to bridge or map applications and databases can be extremely complex. Even relatively simple object-to-relational (O/R) mapping scenarios where a set of objects is partitioned across several relational tables can require transformations that contain outer joins, nested queries, and case statements in order to reassemble objects from tables. Implementing such transformations can be difficult, especially since the data usually needs to be updatable, a common requirement for many enterprise applications. For example, a recent study indicated that coding and configuring object-to-relational (O/R) data access accounts for up to 40% of total project effort.

Since the mid-1990's, client-side data mapping layers have become a popular alternative to handcoding data access logic, funneled by the growth of Internet applications. A core function of such a layer is to provide an updatable view that exposes a data model closely aligned with the application's data model, driven by an explicit mapping. Many commercial products and open source projects have emerged to offer these capabilities. Virtually every enterprise framework provides a client-side persistence layer (e.g., Enterprise Java Bean (EJB) in Java 2 Platform, Enterprise Edition (J2EE)). Most packaged business applications, such as, for instance, Enterprise Resource Planning (ERP) and Customer Relationship Management (CRM) applications incorporate proprietary data access interfaces (e.g., Business Application Programming Interfaces (BAPIs)).

Today's client-side mapping layers offer widely varying degrees of capability, robustness, and total cost of ownership. Typically, the mapping between the application and database artifacts can be represented as a custom structure or schema annotation that can have vague semantics and can drive case-by-case reasoning. A scenario driven implementation limits the range of supported mappings and often yields a fragile runtime that is difficult to extend. Furthermore, building such solutions using views, triggers, and stored procedures is problematic for a number of reasons. First, views containing joins or unions are usually not updatable. Second, defining custom database views and triggers for every application accessing mission-critical enterprise data is rarely acceptable due to security and manageability risks. Moreover, SQL dialects, object-relational features, and procedural extensions vary significantly from one DBMS to the next.

### SUMMARY

The following presents a simplified summary in order to provide a basic understanding of some aspects of the disclosed subject matter. This summary is not an extensive overview, and it is not intended to identify key/critical elements or to delineate the scope thereof. Its sole purpose is to present some concepts in a simplified form as a prelude to the more detailed description that is presented later.

Translating data and data access operations between applications and databases has been a longstanding data management problem. The claimed subject matter in accordance with one illustrative aspect provides systems and methods that construct a relationship between application data and persistent storage by using a declarative mapping that can be compiled into bidirectional views that can drive data transformation engines. Expressing the application model as a view on the database can be used to answer queries, while viewing the database in terms of the application model allows leverage of view maintenance algorithms for update translation. As such, the subject matter as claimed enables developers to interact with relational databases via conceptual schema and object-oriented programming surfaces.

To the accomplishment of the foregoing and related ends, certain illustrative aspects of the disclosed and claimed subject matter are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

FIG. 1 illustrates entity framework that can provide a mapping driven data access layer for developers of data intensive applications in accordance with the claimed subject matter.

FIG. 2 illustrates a system that facilitates and effectuates conversion or transformation of submitted query views or mappings into an internal representation or bidirectional view in accordance with one aspect of the claimed subject matter.

FIG. 3 provides a more detailed illustration of transformation engine in accordance with an aspect of the claimed subject matter.

FIG. 4 illustrates a system implemented on a machine that facilitates and effectuates conversion or transformation of submitted query views or mappings into an internal representation or bidirectional view in accordance with an aspect of the claimed subject matter.

FIG. 5 provides a further depiction of a machine implemented system that facilitates and effectuates conversion or transformation of submitted query views or mappings into an internal representation or bidirectional view in accordance with an aspect of the subject matter as claimed.

FIG. 6 illustrates yet another aspect of the machine implemented system that facilitates and effectuates conversion or transformation of submitted query views or mappings into an internal representation or bidirectional view in accordance with an aspect of the claimed subject matter.

FIG. 7 depicts a further illustrative aspect of the machine implemented system that facilitates and effectuates conversion or transformation of submitted query views or mappings into an internal representation or bidirectional view in accordance with an aspect of the claimed subject matter.

FIG. 8 illustrates another illustrative aspect of a system implemented on a machine that facilitates and effectuates conversion or transformation of submitted query views or mappings into an internal representation or bidirectional view in accordance of yet another aspect of the claimed subject matter.

FIG. 9 depicts yet another illustrative aspect of a system that facilitates and effectuates conversion or transformation of submitted query views or mappings into an internal representation or bidirectional view in accordance with an aspect of the subject matter as claimed.

FIG. 10 illustrates a flow diagram of a machine implemented method that effectuates and facilitates conversion or transformation of submitted query views or mappings into an internal representation or bidirectional view in accordance with an aspect of the claimed subject matter.

FIG. 11 illustrates a block diagram of a computer operable to execute the disclosed system in accordance with an aspect of the claimed subject matter.

FIG. 12 illustrates a schematic block diagram of an exemplary computing environment for processing the disclosed architecture in accordance with another aspect.

### DETAILED DESCRIPTION

The subject matter as claimed is now described with reference to the drawings, wherein like reference numerals are used to refer to like elements throughout. In the following description, for purposes of explanation, numerous specific details are set forth in order to provide a thorough understanding thereof. It may be evident, however, that the claimed subject matter can be practiced without these specific details. In other instances, well-known structures and devices are shown in block diagram form in order to facilitate a description thereof.

The subject matter as claimed in accordance with one illustrative aspect can build a mapping driven data access layer that provides a general purpose mechanism for supporting updatable views. It enables building client-side data access layers in a principled way that can be exploited inside a database engine. The system can include employing declarative languages that have well-defined semantics and that put a wide range of mapping scenarios within reach of novice or non-expert users. Such declarative languages can be utilized to produce mappings that can be compiled into bidirectional views, termed query and update views that can drive query and update processing in a runtime engine.

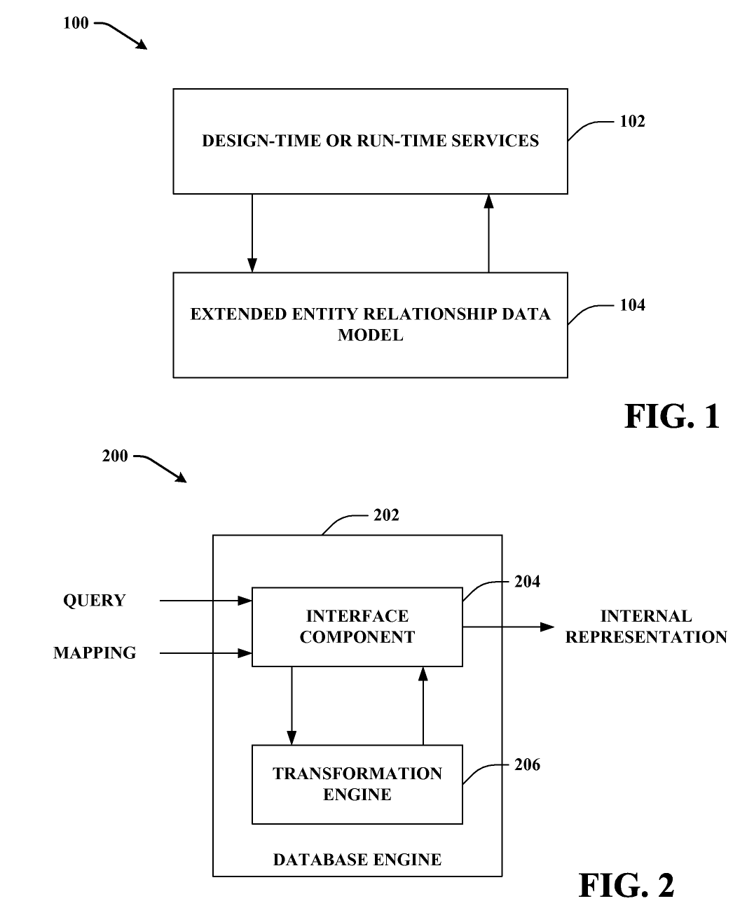

FIG. 1 depicts an illustrative entity framework 100 that can provide a mapping driven data access layer for developers of data intensive applications. The entity framework 100 can include a set of design time and runtime services 102 and an entity data model (EDM) 104. Design time and runtime services 102 can allow developers to describe the application data using an entity schema and to interact with it (e.g., the schema) at a high level of abstraction appropriate for business applications.

The central goal of the entity framework 100 is to increase the level of abstraction at which applications operate when it comes to data. Accordingly, the entity framework 100 offers three major data programming facilities. First, developers can manipulate the data represented in the entity schema using an extension of SQL (e.g., Entity SQL) that can deal with inheritance, associations, etc. This capability enables general-purpose database development against the conceptual schema and is important for applications that do not need an object layer, such as business reporting. Second, the entity schema can be utilized to generate object oriented interfaces in several major programming languages. In this way, persistent data can be accessed using create/read/update/delete operations on objects. Third, queries against the generated object model can be produced using a language-integrated mechanism (LINQ), which enables compile time checking of queries.

Entity data model (EDM) 104 can distinguish entity types, complex types, and primitive types. Instances of entity types, called entities, can be organized into persistent collections called entity sets. An entity set of type T holds entities of type T or any type that derives from T. Each entity type has a key, which uniquely identifies an entity in the entity set. Entities and complex values may have properties holding other complex values or primitive values. Like entity types, complex types can be specialized through inheritance. However, complex values can exist only as part of some entity. Entities can participate in 1:1, 1:n, or m:n associations (where m and n are integers greater than or equal to 1), which essentially relate to the keys of the respective entities.

The extension to SQL (e.g., Entity SQL) can be a data manipulation language based in part on SQL and allows retrieving entities from entity sets and navigating from an entity to a collection of entities reachable via a given association. Path expressions can be used to “dot” into complex values. Type interrogation can be performed using <value> IS OF <type> or IS OF ONLY predicates. The data manipulation language based at least in part on SQL can allow instantiating new entities or complex values similarly to the “new” construct in programming languages. Moreover, the data manipulation language (e.g., Entity SQL) can support a tuple constructor that can produce row types and uses reference types.

FIG. 2 illustrates a system 200 that facilitates and effectuates conversion or transformation of query views posited in a data manipulation language based on SQL and/or mappings composed, for example, in an Extensible Markup Language (XML) or Comma Separated Values (CSV) into an internal representation or bi-directional view. As depicted system 200 can include database engine 202 that, in one illustrative aspect can produce internal representations or bi-directional views that can be employed to drive query and update processing in a runtime engine. Database engine 202 can include interface 204 (hereinafter referred to as “interface 204”). Interface 204 can receive data from a multitude of sources, such as, for example, query views composed in a data manipulation language based on SQL (e.g., Entity SQL) or mappings written in an Extensible Markup Language (XML), Comma Separated Values (CSV), and the like. Additionally, interface 204 can receive data associated with client applications, services, users, clients, devices, and/or entities involved with a particular transaction, a portion of a transaction, and thereafter convey the received information to a transformation engine 206 for further analysis. Further, interface 204 can receive from transformation engine 206 internal representations or bidirectional views that can subsequently be utilized to drive query and update processing in a runtime engine.

Interface 204 can provide various adapters, connectors, channels, communication pathways, etc. to integrate the various components included in system 200 into virtually any operating system and/or database system and/or with one another. Additionally, interface 204 can provide various adapters, connectors, channels, communication modalities, etc. that provide for interaction with various components that can comprise system 200, and/or any other component (external and/or internal), data and the like associated with system 200.

Further database engine 202 can also include transformation engine 206 that can receive query views typically written in a data manipulation language generally based on SQL (e.g., Entity SQL) or mappings composed in an Extensible Markup Language (XML), Comma Separated Values (CSV), and the like. Transformation engine 206 can, upon receipt of the query view written in a data manipulation language based on SQL or mappings composed in an Extensible Markup Language (XML) or Comma Separated Values (CSV), for instance, can convert these inputs into an internal representation that can allow a runtime engine (not shown) to actuate or manage query and update processing.

Database developers or users may often wish to define a mapping that is more complex than what one could define with a traditional field-by-field, or line-by-line mapping. Accordingly, developers or users will need to handle challenging scenarios where the mapping can go beyond simple projections and renames and requires complex functions and aggregates. When a developer defines a complex mapping that goes beyond the constrained capabilities of the framework, it is desirable that the Application Programming Interface (API) surface for the application remain the same as for simple mappings. For instance, consider the following code that can be supplied via interface 204 to transformation engine 206:

```
protected void QueryVendors( )
{
  using (NorthwindEntities context = new NorthwindEntities( ))
  {
    var vendors = from o in context.Vendor select o;
  }
}
```

The language-integrated mechanism (LINQ) query in the above code queries all of the Vendors from the underlying database. The above code should work regardless of whether or not a mid-tier view is compiled from field by field mappings or a query view that the developer or user specified. Additionally, if the user or developer defines more interesting queries with predicates the above query should compose nicely over the developer or user specified view. For example, the following code should work consistently regardless of the manner in which the code is specified:

```
protected void QueryVendors( )
{
  using (NorthwindEntities context = new NorthwindEntities( ))
  {
    var vendors = from o in context.Vendor where o.ID > 10 select o;
  }
}
```

An illustrative result that can emanate from transformation engine 206 can be a query formatted in a data manipulation language generally based on SQL (e.g., Entity SQL), which can subsequently be employed by a runtime engine (not shown) to manage query and update processing.

Similarly, for example, where transformation engine 206 receives via interface 204 the following mapping:

```
<EntitySetMapping Name=“Categories” StoreEntitySet=“Categories”
        TypeName=“NorthwindModel.Categories”>
  <ScalarProperty Name=“CategoryID” ColumnName=“CategoryID” />
  <ScalarProperty Name=“CategoryName”
  ColumnName=“CategoryName” />
  <ScalarProperty Name=“Description” ColumnName=“Description” />
  <ScalarProperty Name=“Picture” ColumnName=“Picture” />
</EntitySetMapping>
```

The above mapping provides a declarative field by field mapping from the entity properties to the columns in the underlying database table. The result of the conversion process carried out by transformation engine 206 can be the following illustrative query formulated into a data manipulation language generally based on SQL (e.g., Entity SQL) that subsequent user queries can compose on top of:

```
SELECT VALUE -- Constructing Categories
    Northwind.Categories( T1.Categories_CategoryID,
          T1.Categories_CategoryName,
          T1.Categories_Description,
          T1.Categories_Picture)
FROM (
  SELECT
    T.CategoryID AS Categories_CategoryID,
    T.CategoryName AS Categories_CategoryName,
    T.Description AS Categories_Description,
    T.Picture AS Categories_Picture,
    True AS _from0
  FROM NorthwindEntities.Categories AS T
) AS T1
```

Additionally, instead of defining the field-by-field, line-by-line mapping, as above, and delegating the mapping to transformation engine 206 for view generation, developers or users can specify the same view by hand and supply this to transformation engine 206 via interface 204. Such a hand specified view can be consumed by transformation engine 206 and substituted as if it were the result of transformation. Such a hand specified view is exemplified as follows:

```
  <EntitySetMapping Name=“Categories”>
    <QueryView>
SELECT VALUE -- Constructing Categories
    Northwind.Categories( T1.Categories_CategoryID,
              T1.Categories_CategoryName,
              T1.Categories_Description,
              T1.Categories_Picture)
  FROM (
    SELECT
      T.CategoryID AS Categories_CategoryID,
      T.CategoryName AS Categories_CategoryName,
      T.Description AS Categories_Description,
      T.Picture AS Categories_Picture,
      True AS _from0
    FROM NorthwindEntities.Categories AS T
) AS T1
  </QueryView>
</EntitySetMapping>
```

As such the foregoing illustrative view represents an alterative representation of the mapping. Nevertheless, the foregoing solution exemplifies its differentiating value when used with complex logic (as shown below) that typically cannot be expressed in field-by-field or line-by-line mappings.

```
  <EntitySetMapping Name=“ExpensiveProducts”>
    <QueryView>
SELECT VALUE -- Constructing Expensive Products
Northwind.ExpensiveProduct (P.CategoryID, C.CategoryName,
                  null, null, max(P.UnitPrice))
        FROM dbo.Categories as C
          INNER JOIN dbo.Products as P ON
          P.CategoryID = C.CategoryID
          group by P.CategoryID, C.CategoryName
    </QueryView>
  </EntitySetMapping>
```

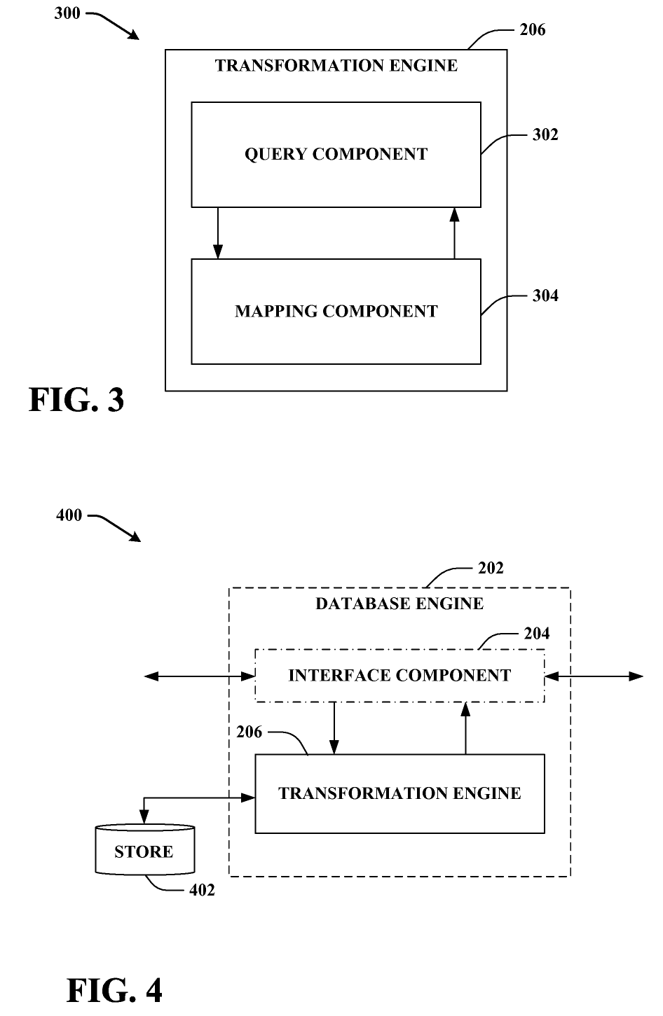

FIG. 3 provides a more detailed illustration 300 of transformation engine 206. As illustrated transformation engine 206 can include a query component 302 that can receive or obtain query views formatted or formulated in a SQL based data manipulation language (e.g., Entity SQL). Upon receipt of query view specified in the SQL based data manipulation language, query component 302 can ascertain whether or not further processing is needed to better formulate the query view into an appropriate internal representation or bidirectional view. Where query component 302 determines that no further processing or reprocessing is required (e.g., possibly because the query view is formulated and utilizes complex logic, or because the received query view has been manually specified) query component 302 can compile the query view into a bidirectional view that can thereafter drive query and update processing in a runtime engine.

Additionally, transformation engine 206 can also include mapping component 304 that can receive or obtain mappings formulated, specified, or formatted in one or more of an Extended Markup Language (XML), Comma Separated Values (CSV), and the like, for instance. On receipt of the mappings mapping component can automatically and dynamically convert or format the received mapping into a query specified in a SQL based data manipulation language (e.g., Entity SQL). Such a conversion or formatting of the received mapping into a query specified in a SQL based data manipulation language can be effectuated in concert with query component 302, but as will be appreciated by those cognizant in the art the claimed subject matter in not necessarily so limited. Once mapping component 304 has transformed or converted the mapping into an appropriate form (e.g., through utilization of the data manipulation language), mapping component can compile the resultant query into a bidirectional view that can then be utilized by a runtime engine to actuate or manage subsequent query and update processing.

FIG. 4 depicts an aspect of a system 400 facilitates and effectuates conversion or transformation of submitted query views or mappings into an internal representation or bidirectional view. System 400 can include database engine 202 that can comprise interface 204 and transformation engine 206. Additionally, system 400 can include store 402 that can include any suitable data necessary for transformation engine 206 to facilitate it aims. For instance, store 402 can include information regarding user data, data related to a portion of a transaction, credit information, historic data related to a previous transaction, a portion of data associated with purchasing a good and/or service, a portion of data associated with selling a good and/or service, geographical location, online activity, previous online transactions, activity across disparate network, activity across a network, credit card verification, membership, duration of membership, communication associated with a network, buddy lists, contacts, questions answered, questions posted, response time for questions, blog data, blog entries, endorsements, items bought, items sold, products on the network, information gleaned from a disparate website, information gleaned from the disparate network, ratings from a website, a credit score, geographical location, a donation to charity, or any other information related to software, applications, web conferencing, and/or any suitable data related to transactions, etc.

It is to be appreciated that store 402 can be, for example, volatile memory or non-volatile memory, or can include both volatile and non-volatile memory. By way of illustration, and not limitation, non-volatile memory can include read-only memory (ROM), programmable read only memory (PROM), electrically programmable read only memory (EPROM), electrically erasable programmable read only memory (EEPROM), or flash memory. Volatile memory can include random access memory (RAM), which can act as external cache memory. By way of illustration rather than limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM) and Rambus dynamic RAM (RDRAM). Store 402 of the subject systems and methods is intended to comprise, without being limited to, these and any other suitable types of memory. In addition, it is to be appreciated that store 402 can be a server, a database, a hard drive, and the like.

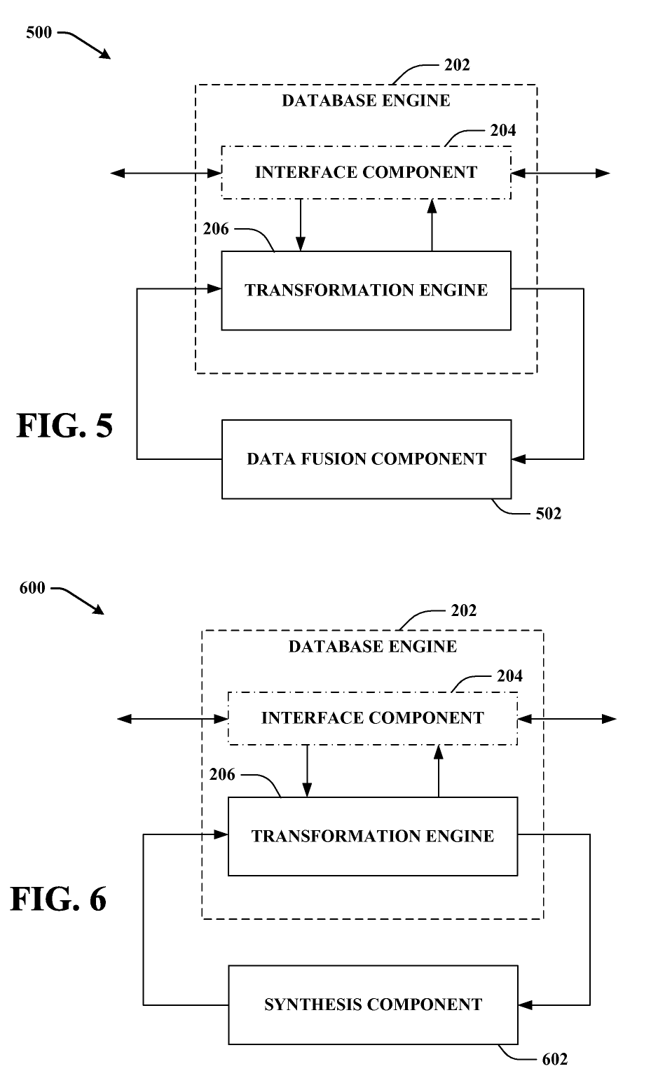

FIG. 5 provides yet a further depiction of a system 500 that facilitates and effectuates conversion or transformation of submitted query views or mappings into an internal representation or bidirectional view in accordance with an aspect of the claimed subject matter. As depicted, system 500 can include a data fusion component 502 that can be utilized to take advantage of information fission which may be inherent to a process (e.g., receiving and/or deciphering inputs) relating to analyzing inputs through several different sensing modalities. In particular, one or more available inputs may provide a unique window into a physical environment (e.g., an entity inputting instructions) through several different sensing or input modalities. Because complete details of the phenomena to be observed or analyzed may not be contained within a single sensing/input window, there can be information fragmentation which results from this fission process. These information fragments associated with the various sensing devices may include both independent and dependent components.

The independent components may be used to further fill out (or span) an information space; and the dependent components may be employed in combination to improve quality of common information recognizing that all sensor/input data may be subject to error, and/or noise. In this context, data fusion techniques employed by data fusion component 502 may include algorithmic processing of sensor/input data to compensate for inherent fragmentation of information because particular phenomena may not be observed directly using a single sensing/input modality. Thus, data fusion provides a suitable framework to facilitate condensing, combining, evaluating, and/or interpreting available sensed or received information in the context of a particular application.

FIG. 6 provides a further depiction of a system 600 that facilitates and effectuates conversion or transformation of submitted query views or mappings into an internal representation or bidirectional view in accordance with an aspect of the claimed subject matter. As illustrated system 600 can, for example, employ synthesizing component 602 to combine, or filter information received from a variety of inputs (e.g., text, speech, gaze, environment, audio, images, gestures, noise, temperature, touch, smell, handwriting, pen strokes, analog signals, digital signals, vibration, motion, altitude, location, GPS, wireless, etc.), in raw or parsed (e.g. processed) form. Synthesizing component 602 through combining and filtering can provide a set of information that can be more informative, all accurate (e.g., with respect to an entity's communicative or informational goals) and information from just one or two modalities, for example. As discussed in connection with FIG. 5, the data fusion component 502 can be employed to learn correlations between different data types, and the synthesizing component 602 can employ such correlations in connection with combining, or filtering the input data.

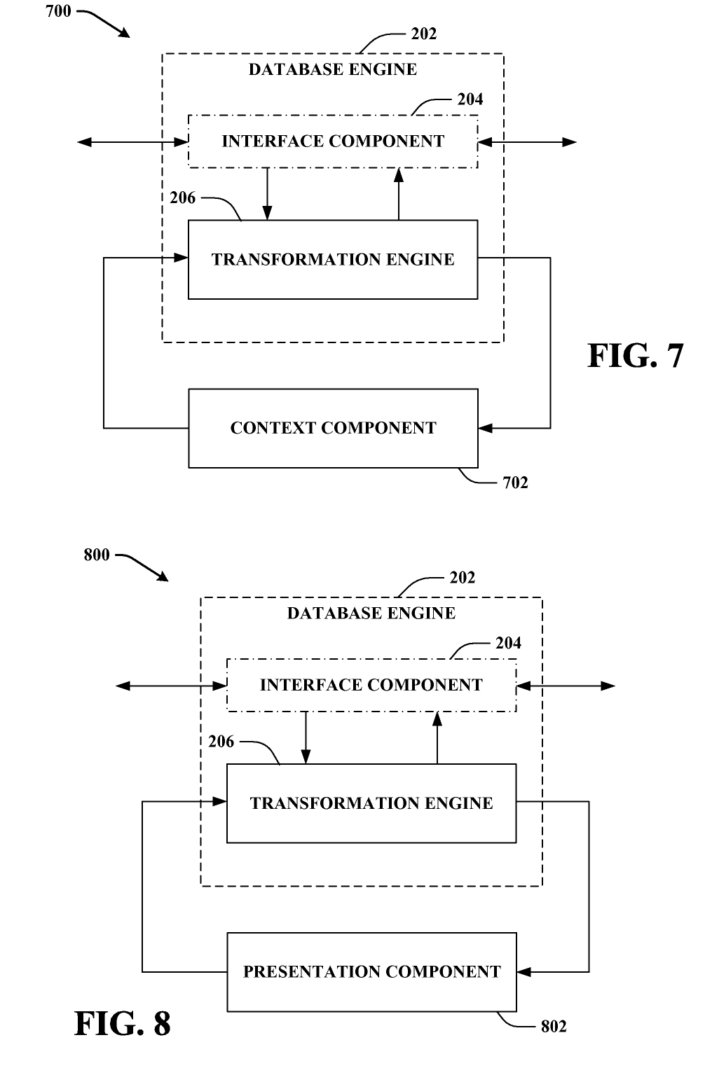

FIG. 7 provides a further illustration of a system 700 that facilitates and effectuates conversion or transformation of submitted query views or mappings into an internal representation or bidirectional view in accordance with an aspect of the claimed subject matter. As illustrated system 700 can, for example, employ context component 702 to determine context associated with a particular action or set of input data. As can be appreciated, context can play an important role with respect understanding meaning associated with particular sets of input, or intent of an individual or entity. For example, many words or sets of words can have double meanings (e.g., double entendre), and without proper context of use or intent of the words the corresponding meaning can be unclear thus leading to increased probability of error in connection with interpretation or translation thereof. The context component 702 can provide current or historical data in connection with inputs to increase proper interpretation of inputs. For example, time of day may be helpful to understanding an input—in the morning, the word “drink” would likely have a high a probability of being associated with coffee, tea, or juice as compared to be associated with a soft drink or alcoholic beverage during late hours. Context can also assist in interpreting uttered words that sound the same (e.g., steak and, and stake). Knowledge that it is near dinnertime of the user as compared to the user campaign would greatly help in recognizing the following spoken words “I need a steak/stake”. Thus, if the context component 702 had knowledge that the user was not camping, and that it was near dinnertime, the utterance would be interpreted as “steak”. On the other hand, if the context component 702 knew (e.g., via GPS system input) that the user recently arrived at a camping ground within a national park; it might more heavily weight the utterance as “stake”.

In view of the foregoing, it is readily apparent that utilization of the context component 702 to consider and analyze extrinsic information can substantially facilitate determining meaning of sets of inputs.

FIG. 8 a further illustration of a system 800 that facilitates and effectuates conversion or transformation of submitted query views or mappings into an internal representation or bidirectional view in accordance with an aspect of the claimed subject matter. As illustrated, system 800 can include presentation component 802 that can provide various types of user interface to facilitate interaction between a user and any component coupled to transformation engine 206. As illustrated, presentation component 802 is a separate entity that can be utilized with transformation engine 206. However, it is to be appreciated that presentation component 802 and/or other similar view components can be incorporated into transformation engine 206 and/or a standalone unit. Presentation component 802 can provide one or more graphical user interface, command line interface, and the like. For example, the graphical user interface can be rendered that provides the user with a region or means to load, import, read, etc., data, and can include a region to present the results of such. These regions can comprise known text and/or graphic regions comprising dialog boxes, static controls, drop-down menus, list boxes, pop-up menus, edit controls, combo boxes, radio buttons, check boxes, push buttons, and graphic boxes. In addition, utilities to facilitate the presentation such as vertical and/or horizontal scrollbars for navigation and toolbar buttons to determine whether a region will be viewable can be employed. For example, the user can interact with one or more of the components coupled and/or incorporated into transformation engine 206.

Users can also interact with regions to select and provide information via various devices such as a mouse, roller ball, keypad, keyboard, and/or voice activation, for example. Typically, the mechanism such as a push button or the enter key on the keyboard can be employed subsequent to entering the information in order to initiate, for example, a query. However, it is to be appreciated that the claimed subject matter is not so limited. For example, nearly highlighting a checkbox can initiate information conveyance. In another example, a command line interface can be employed. For example, the command line interface can prompt (e.g., via text message on a display and an audio tone) the user for information via a text message. The user can then provide suitable information, such as alphanumeric input corresponding to an option provided in the interface prompt or an answer to a question posed in the prompt. It is to be appreciated that the command line interface can be employed in connection with a graphical user interface and/or application programming interface (API). In addition, the command line interface can be employed in connection with hardware (e.g., video cards) and/or displays (e.g., black-and-white, and EGA) with limited graphic support, and/or low bandwidth communication channels.

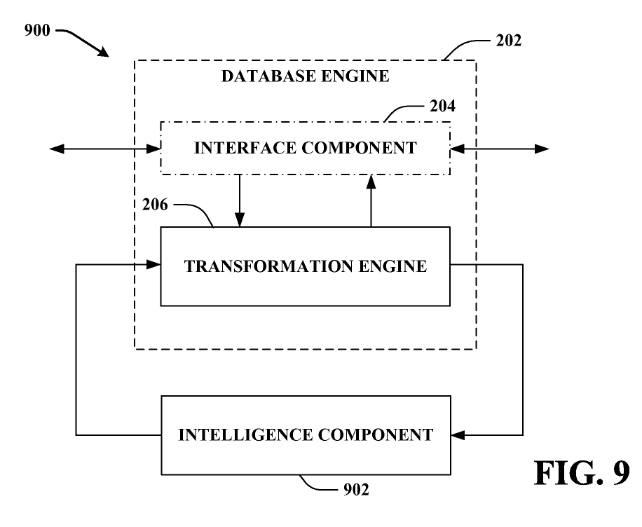

FIG. 9 depicts a system 900 that employs artificial intelligence to facilitate and effectuate conversion or transformation of submitted query views or mappings into an internal representation or bidirectional view in accordance with an aspect of the subject matter as claimed. Accordingly, as illustrated, system 900 can include an intelligence component 902 that can employ a probabilistic based or statistical based approach, for example, in connection with making determinations or inferences. Inferences can be based in part upon explicit training of classifiers (not shown) before employing system 200, or implicit training based at least in part upon system feedback and/or users previous actions, commands, instructions, and the like during use of the system. Intelligence component 902 can employ any suitable scheme (e.g., numeral networks, expert systems, Bayesian belief networks, support vector machines (SVMs), Hidden Markov Models (HMMs), fuzzy logic, data fusion, etc.) in accordance with implementing various automated aspects described herein. Intelligence component 902 can factor historical data, extrinsic data, context, data content, state of the user, and can compute cost of making an incorrect determination or inference versus benefit of making a correct determination or inference. Accordingly, a utility-based analysis can be employed with providing such information to other components or taking automated action. Ranking and confidence measures can also be calculated and employed in connection with such analysis.

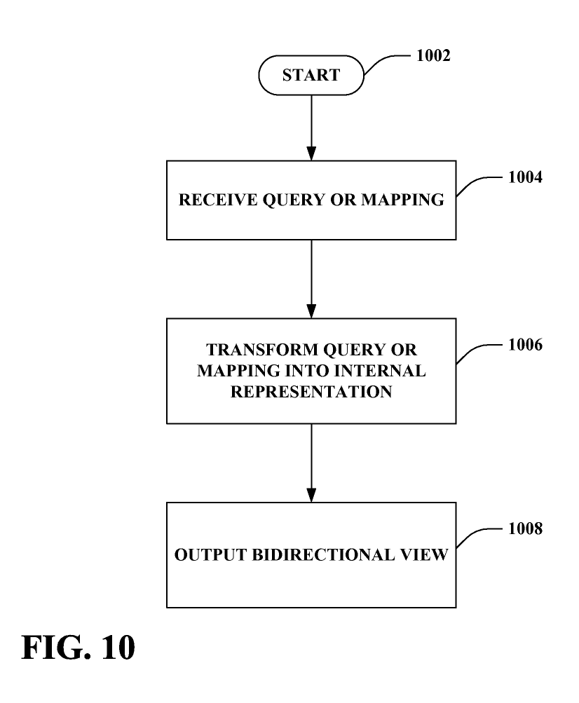

In view of the exemplary systems shown and described supra, methodologies that may be implemented in accordance with the disclosed subject matter will be better appreciated with reference to the flow chart of FIG. 10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers.

The claimed subject matter can be described in the general context of computer-executable instructions, such as program modules, executed by one or more components. Generally, program modules can include routines, programs, objects, data structures, etc. that perform particular tasks or implement particular abstract data types. Typically the functionality of the program modules may be combined and/or distributed as desired in various aspects.

FIG. 10 illustrates an illustrative methodology 1000 that can be implemented in database engine 202. At 1002 various and sundry initialization tasks and processes can be undertaken after which method 1000 can proceed to 1004. At 1004 methodology 1000 can receive, obtain, or retrieve query views or mappings. At 1006 the method can transform or compile the received, retrieved, or obtained query views or mappings into an appropriate internal representation. At 1008 the resultant bidirectional view can be output. Such bidirectional views can thereafter be employed by a runtime engine to drive subsequent query and update processing.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

The benefit of object technology arises out of three basic principles: encapsulation, polymorphism and inheritance. Objects hide or encapsulate the internal structure of their data and the algorithms by which their functions work. Instead of exposing these implementation details, objects present interfaces that represent their abstractions cleanly with no extraneous information. Polymorphism takes encapsulation one-step further—the idea being many shapes, one interface. A software component can make a request of another component without knowing exactly what that component is. The component that receives the request interprets it and figures out according to its variables and data how to execute the request. The third principle is inheritance, which allows developers to reuse pre-existing design and code. This capability allows developers to avoid creating software from scratch. Rather, through inheritance, developers derive subclasses that inherit behaviors that the developer then customizes to meet particular needs.

In particular, an object includes, and is characterized by, a set of data (e.g., attributes) and a set of operations (e.g., methods), that can operate on the data. Generally, an object's data is ideally changed only through the operation of the object's methods. Methods in an object are invoked by passing a message to the object (e.g., message passing). The message specifies a method name and an argument list. When the object receives the message, code associated with the named method is executed with the formal parameters of the method bound to the corresponding values in the argument list. Methods and message passing in OOP are analogous to procedures and procedure calls in procedure-oriented software environments.

However, while procedures operate to modify and return passed parameters, methods operate to modify the internal state of the associated objects (by modifying the data contained therein). The combination of data and methods in objects is called encapsulation. Encapsulation provides for the state of an object to only be changed by well-defined methods associated with the object. When the behavior of an object is confined to such well-defined locations and interfaces, changes (e.g., code modifications) in the object will have minimal impact on the other objects and elements in the system.

Each object is an instance of some class. A class includes a set of data attributes plus a set of allowable operations (e.g., methods) on the data attributes. As mentioned above, OOP supports inheritance—a class (called a subclass) may be derived from another class (called a base class, parent class, etc.), where the subclass inherits the data attributes and methods of the base class. The subclass may specialize the base class by adding code which overrides the data and/or methods of the base class, or which adds new data attributes and methods. Thus, inheritance represents a mechanism by which abstractions are made increasingly concrete as subclasses are created for greater levels of specialization.

As used in this application, the terms “component” and “system” are intended to refer to a computer-related entity, either hardware, a combination of hardware and software, software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Artificial intelligence based systems (e.g., explicitly and/or implicitly trained classifiers) can be employed in connection with performing inference and/or probabilistic determinations and/or statistical-based determinations as in accordance with one or more aspects of the claimed subject matter as described hereinafter. As used herein, the term “inference,” “infer” or variations in form thereof refers generally to the process of reasoning about or inferring states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

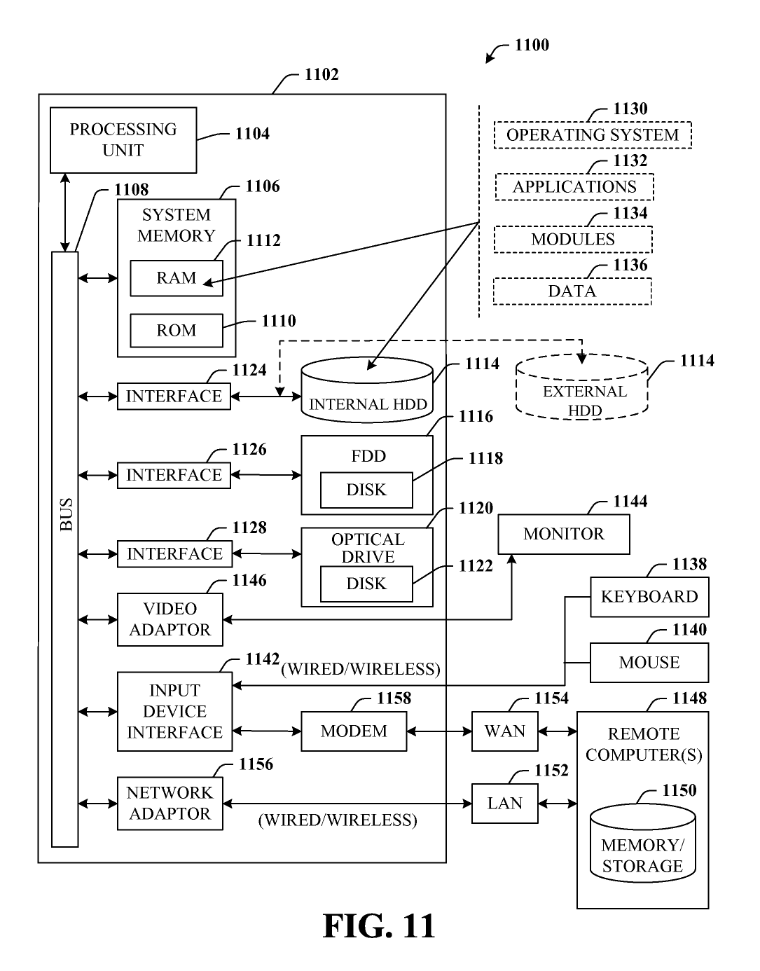

Referring now to FIG. 11, there is illustrated a block diagram of a computer operable to execute the disclosed system. In order to provide additional context for various aspects thereof, FIG. 11 and the following discussion are intended to provide a brief, general description of a suitable computing environment 1100 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 11, the exemplary environment 1100 for implementing various aspects includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system bus 1108 can be any of several types of bus structure that may further interconnect to a memory bus (with or without a memory controller), a peripheral bus, and a local bus using any of a variety of commercially available bus architectures. The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1194 interface technologies. Other external drive connection technologies are within contemplation of the claimed subject matter.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods of the disclosed and claimed subject matter.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is to be appreciated that the claimed subject matter can be implemented with various commercially available operating systems or combinations of operating systems.

A user can enter commands and information into the computer 1102 through one or more wired/wireless input devices, e.g., a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1194 serial port, a game port, a USB port, an IR interface, etc.

A monitor 1144 or other type of display device is also connected to the system bus 1108 via an interface, such as a video adapter 1146. In addition to the monitor 1144, a computer typically includes other peripheral output devices (not shown), such as speakers, printers, etc.

The computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g., a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

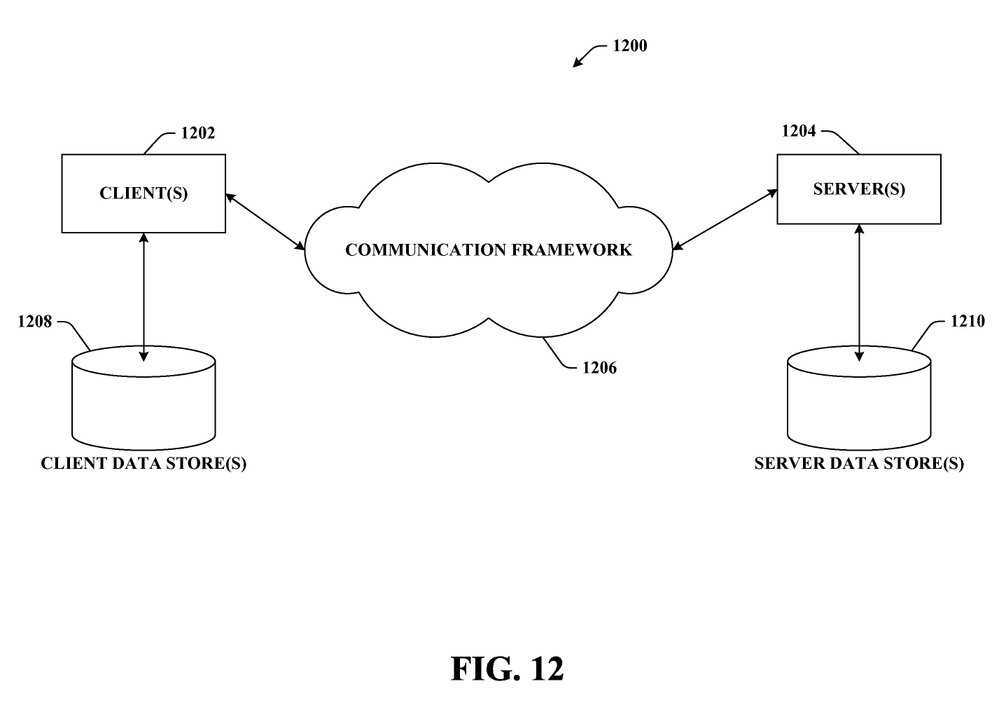

Referring now to FIG. 12, there is illustrated a schematic block diagram of an exemplary computing environment 1200 for processing the disclosed architecture in accordance with another aspect. The system 1200 includes one or more client(s) 1202. The client(s) 1202 can be hardware and/or software (e.g., threads, processes, computing devices). The client(s) 1202 can house cookie(s) and/or associated contextual information by employing the claimed subject matter, for example.

The system 1200 also includes one or more server(s) 1204. The server(s) 1204 can also be hardware and/or software (e.g., threads, processes, computing devices). The servers 1204 can house threads to perform transformations by employing the claimed subject matter, for example. One possible communication between a client 1202 and a server 1204 can be in the form of a data packet adapted to be transmitted between two or more computer processes. The data packet may include a cookie and/or associated contextual information, for example. The system 1200 includes a communication framework 1206 (e.g., a global communication network such as the Internet) that can be employed to facilitate communications between the client(s) 1202 and the server(s) 1204.

Communications can be facilitated via a wired (including optical fiber) and/or wireless technology. The client(s) 1202 are operatively connected to one or more client data store(s) 1208 that can be employed to store information local to the client(s) 1202 (e.g., cookie(s) and/or associated contextual information). Similarly, the server(s) 1204 are operatively connected to one or more server data store(s) 1210 that can be employed to store information local to the servers 1204.

What has been described above includes examples of the disclosed and claimed subject matter. It is, of course, not possible to describe every conceivable combination of components and/or methodologies, but one of ordinary skill in the art may recognize that many further combinations and permutations are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system that effectuates and facilitates generation of bidirectional views, comprising:
a component that receives from an interface a query view or a mapping, the component transforms the query view or the mapping into an internal representation, the internal representation compiled into a bidirectional view.

2. The system of claim 1, the bidirectional view employed to drive query or update processing in a runtime engine.

3. The system of claim 1, the query view composed in a data manipulation language based at least in part on SQL.

4. The system of claim 1, the mapping formulated in an Extensible Markup Language (XML) or as Comma Separated Values (CSV).

5. The system of claim 1, the component based at least in part on the query view reformulates the query view into a data manipulation language based at least in part on SQL.

6. The system of claim 5, the component reformulates the query view by utilizing a fragment composed in the data manipulation language.

7. The system of claim 5, the data manipulation language allows entity retrieval from an entity set.

8. The system of claim 1, the component converts the mapping automatically into a data manipulation language based at least in part on SQL.

9. The system of claim 1, the query received by the interface as a complete full formed query written in a data manipulation language requiring no conversion by the component.

10. The system of claim 9, the complete full formed query compiled directly into the bidirectional view.

11. The system of claim 1, the internal representation formulated in a data manipulation language based at least in part on SQL.

12. A method that generates bidirectional views, comprising:
retrieving a query view or a mapping;
converting the query view or the mapping into an internal representation;
compiling the internal representation into a bidirectional view; and
utilizing the bidirectional view to actuate query or update processing in a relational database system.

13. The method of claim 12, the converting further includes utilizing a data manipulation language to reformulate the query view.

14. The method of claim 13, reformulation of the query view includes manipulating data manipulation language fragments.

15. The method of claim 13, the reformulation of the query transforms the query into a standard form of the data manipulation language.

16. The method of claim 12, the data manipulation language permits navigation from an entity to a collection of entities reachable via an association.

17. The method of claim 12, the query specified in a data manipulated language based at least in part on SQL.

18. The method of claim 12, the mapping formulated at least in part in an extensible markup language or as comma separated values.

19. The method of claim 12, the internal representation formulated in a data manipulation language based at least in part on SQL.

20. A system that produces bidirectional views, comprising:
means for obtaining queries or mappings;
means for generating an internal representation of the queries or mappings, the internal representation formulated in a data manipulation language based at least in part on SQL;
means for compiling the internal representation into a bidirectional view employed to effectuate query or update processing in a means for persisting relational data.
